(19) United States
(12) Patent Application Publication
(10) Pub. No.: US 2004/0243856 A1
(43) Pub. Date: Dec. 2, 2004

(54) Four factor authentication system and method

(76) Inventor: Will Shatford, La Canada, CA (US)

Correspondence Address: DILWORTH PAXSON LLP, 3200 MELLON BANK CENTER, 1735 MARKET STREET, PHILADELPHIA, PA, 19103, US

(21) Appl. No.: 10/856,483

(22) Filed: May 28, 2004

Related U.S. Application Data
(60) Provisional application No. 60/474,030, filed on May 29, 2003.

(51) Int. Cl. H04L 9/32

(52) U.S. Cl. 713/202

(57) ABSTRACT

The present invention comprises a system and method for accessing secure information wherein a user signal is read to verify that a user of a device for accessing the information is a valid user. Upon verification of the user, an encrypted passcode is generated and displayed to the user including location information, indicative of the user's proximate location, and a code generated using a user specific code algorithm. The resulting passcode is forwarded to an issuer of the device and validated, thereby authorizing or denying the user access to the requested information.

### REFERENCE TO RELATED APPLICATIONS

This application claims priority to U.S. Provisional Application No. 60/474,030, filed May 29, 2003, which disclosure is incorporated herein by reference.

### FIELD OF THE INVENTION

The present invention relates generally to the access of information. More specifically, the present invention relates to the authentication and verification of a user requesting access to protected information.

### BACKGROUND

Protection of information and access to facilities has become a larger issue as technology continues to expand. It is very important to confirm the identity of a person for access to computers and facilities. As the level of security increases so does the need for better user authentication. There are multiple levels of user authentication for securing access to data and facilities. The most general form is referred to as one-factor and is typically related to “what you know.” A simple example is entry of a user-name and password to log onto a computer. This is not a very secure method because most passwords are very simple or easy to guess, or are written down. However, such security measures may be good enough if you only need to gain access your own home computer, or if your network does not contain any confidential or secret information.

Recently, more secure environments have increased user authentication requirements to two-factors, “what you know” and “what you have.” For example, a Secure ID card may display a new random number every minute. A typical login, then, would require (1) entry of a user-name and password (“what you know”) and (2) entry of the random number displayed on the card (“what you have”). This increased security though does not prevent people from sharing the card (especially common for accessing online financial information sites) and, therefore, may not be sufficient for enforcing licensing and for true non-repudiation. Other two-factor cards change the random number with each access, but many users of these cards simply write down a series of 10 or 20 access numbers so that they don't need to carry the card. Having a written list of pass codes completely negates the purpose of the card.

Very secure environments have increased access to three-factors, “what you know,” “what you have,” and “who you are.” Biometric access can provide this third level of security. These systems typically (1) require insertion of a Smart Card (“what you have”), verification of a fingerprint (2) before a verification signal is generated (“who you are”), which then permits, or is used as part of, the (3) user name and password login (“what you know”).

Although, three-factor authorization is secure, more secure sytems are needed. Accordingly, there has, until the present invention, existed a need for an improved safe, secure and efficient system, and method for authenticating user access to protected information.

### SUMMARY

The present invention comprises an apparatus, system and method for accessing secure information wherein a user signal is read to verify that a user of a device for accessing the information is a valid user. Upon verification of the user, an encrpyted passcode is generated and displayed to the user including location information, indicative of the user's proximate location, and a code generated using a user specific code algorithm. The resulting passcode is forwarded to an issuer of the device and validated, thereby authorizing or denying the user access to the requested information.

It is an object of the invention to provide device for accessing information comprising an authenticator for verifying that a user of the device is the authorized user. The authenticator comprises a memory in which a verification user signal is stored, a locator for generating a location signal indicative of the proximate location of the user at the time of authentication, and a processor, coupled to the memory and locator, for generating a passcode including the location signal.

It is also an object of the invention to provide method for authorizing use of a device. The method comprises the steps of reading a signal entered by the user, comparing the read signal to a stored verification user signal, if the read signal is equivalent to the verification user signal, retrieving location information relating to the proximate location of the user at the time of authentication, generating a passcode including the location information, forwarding to an issuer, at and issuer network, the passcode, and authorizing the use of the device in response to the received passcode.

It is another object of the invention to provide a system for authorizing use of a device to access information. The system comprises the device, including an authenticator for verifying that the user of the device is an authorized user. The authenticator comprises a memory for storing a verification user signal, a locator for generating a location signal indicative of the proximate location of a user at the time of authentication, and a processor, coupled to the memory and locator, for generating a passcode including the location signal, said passcode forwarded to an issuer network for authorizing access. The issuer network comprises a customer database having customer information for a plurality of users, an issuer code processor, responsive to said customer database, for decrypting said passcode from said user and determining whether said user is allowed access, and a response generator for generating an authorization signal in response to said code processor and said database.

Additional objects, advantages and novel features of the invention will be set forth in part in the description, examples and figures which follow, all of which are intended to be for illustrative purposes only, and not intended in any way to limit the invention, and in part will become apparent to those skilled in the art on examination of the following, or may be learned by practice of the invention.

### BRIEF DESCRIPTION OF THE DRAWINGS

FIG. 1 is a block diagram of an exemplary authentication device in accordance with a preferred embodiment of the present invention.

FIG. 2 is an exemplary illustration of the card device in accordance with a preferred embodiment of the present invention that may be used for accessing secure facilities.

FIG. 3 is a flow diagram depicting a method of activating an authentication device in accordance with a preferred embodiment of the present invention.

FIG. 4 is an exemplary illustration of a keyfob device in accordance with a preferred embodiment of the present invention.

FIG. 5 is an exemplary illustration of a watch device in accordance with a preferred embodiment of the present invention.

FIG. 6 is a block diagram of an exemplary issuer network in accordance with a preferred emobidment of the present invention.

### DESCRIPTION OF THE PREFERRED EMBODIMENT(S)

The present invention relates to an apparatus, system and method which provide the cardholder with a secure method of transacting business and accessing information.

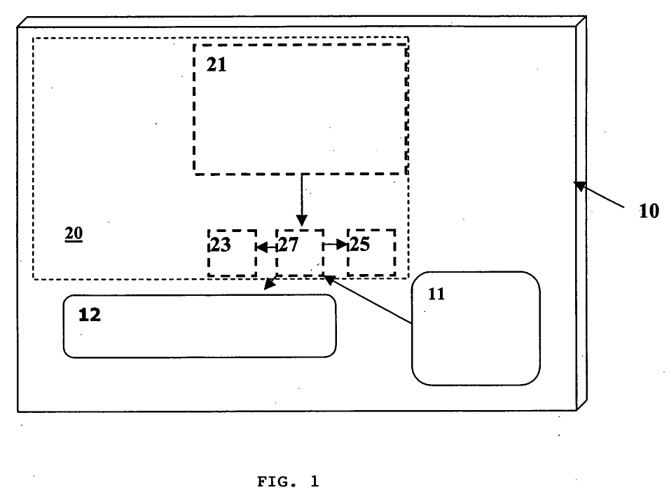

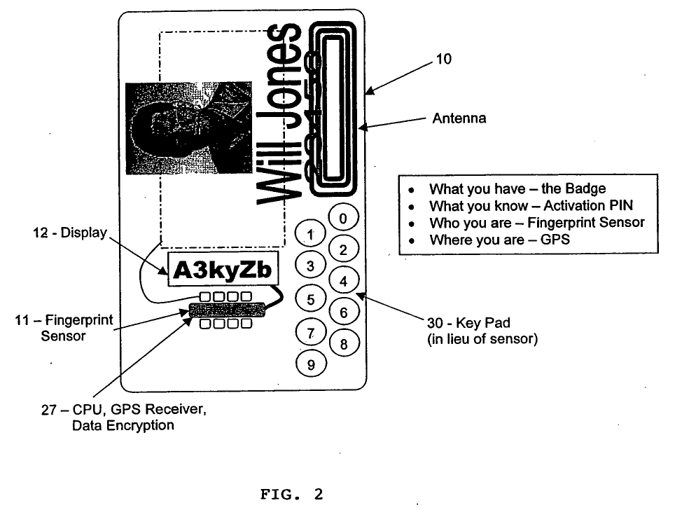

FIG. 1 is a block diagram showing an exemplary authentication device in accordance with a preferred embodiment of the present invention, as represented by a card 10. As will be disclosed below, due to the components included in the card authentication device, card may be thicker than a normal credit card or smart card, but preferebly has a similar shape and size. Although a credit card form is disclosed, card 10 may also be an access card, which is used to grant access to a secure facility, or any other card form factor that can accommodate the components as disclosed below. It is intended that the term “card” encompass all the foregoing types of cards. Card 10 comprises a sensing area 11, a display 12, and an authentication area 20. FIG. 2 is a exemplary illustration of an authentication device 10 in the form of a badge for accessing a secure facility.

Returning to FIG. 1, sensing area 11, coupled to authenticator 20, comprises an area sensitive to any biometric object applied to, or sensed by, the area, such as a finger, thumb, or other part of the user's person that is able to be applied to the sensing area, hereinafter referred to as a “fingerprint.” As disclosed in more detail below, sensing area 11, is coupled to a reader which generates one or more signals associated with the object that is in contact with sensing area 11. Preferably sensing area 11 senses the touch of a finger or thumb for reading by the reader, as disclosed below.

Authenticator 20, coupled to sensing area 11 and display 12, comprises a processor 27, a locator 21, a memory 25, and a clock 23, for authenticating the user of device 10. Processor 27, coupled to clock 23, locator 21 and memory 25, controls the initialization of card 10, as well as, the flow of information between and among the other components, including verification that the cardholder is authorized to use card 10. The methods for initializing card 10 and verifying the user will be disclosed below.

Clock 23, coupled to processor 27, forwards a clock signal to processor 27. For purposes of this disclosure, processor 27 includes a code generator that generates a pseudo-random code each time card 10 is activated by an authorized cardholder, as disclosed below. A code generator algorithm is used by processor 27 in order to generate a pseudo-random code that can be duplicated by a pseudo-random generator at an issuer's network. It should be noted that the code generated by processor 27 is preferably an alphanumeric code, but a code having only numbers or only letters may also be generated and used in the alternative. It is preferable that the code generator algorithm be distinct for each authentication device, thereby ensuring that the code generated by processor 27 is associated with the authorized cardholder. It should be also noted that the term “issuer” as defined herein relates to any entity that provides authentication devices for specific users to have access to specific information or facilities. For purposes of this embodiment, issuer may, for example, be a credit card issuer.

Locator 21, coupled to processor 27, comprises an antenna and geo-locator (not shown). In accordance with a preferred embodiment, locator 21 forwards a location signal to processor 27 indicative of the user's proximate location at the time of the authentication. As those skilled in the area know, geo-locators provide bearing information, such as latitude and longitude, as well as accurate clock information. It should be noted that any antenna and geo-locator may be used to generate the location signal, limited only by its applicability to the present invention. It is preferable that the geo-locator receive Global Positioning System (GPS) data, although information may be received over a cellular network, such as an Assisted Global Positioning System (AGPS).

If the user is authorized to use card 10, processor 27, based on the code generator algorithm, which as noted could be, and is preferably, different for each of a plurality of cardholders, generates a random code. Preferably, a different code is generated each time the card senses the touch of a thumb or finger, and the generated code is valid only for the single transaction, thereby requiring a new code for each transaction. The code and locator information are combined and encrypted, then displayed for the user on display 12 as a one time passcode (OTP), which again is preferably different for each transaction. Display 12 receives the OTP from processor 27 and displays it to the user, in this embodiment, the cardholder.

If processor 27 determines that the user is not the authorized cardholder, display 12 would display an error message. Alternatively, when the user is found to be unauthorized, display 12 is not activated. It should be noted that although a processor 27 has been disclosed as including a pseudo-random generator and a biometric reader, each of these components could be included in card 10 as a separate component. This is also true for the other components that have been disclosed in combination with one another. Each component may or may not be used with all of the other identified components.

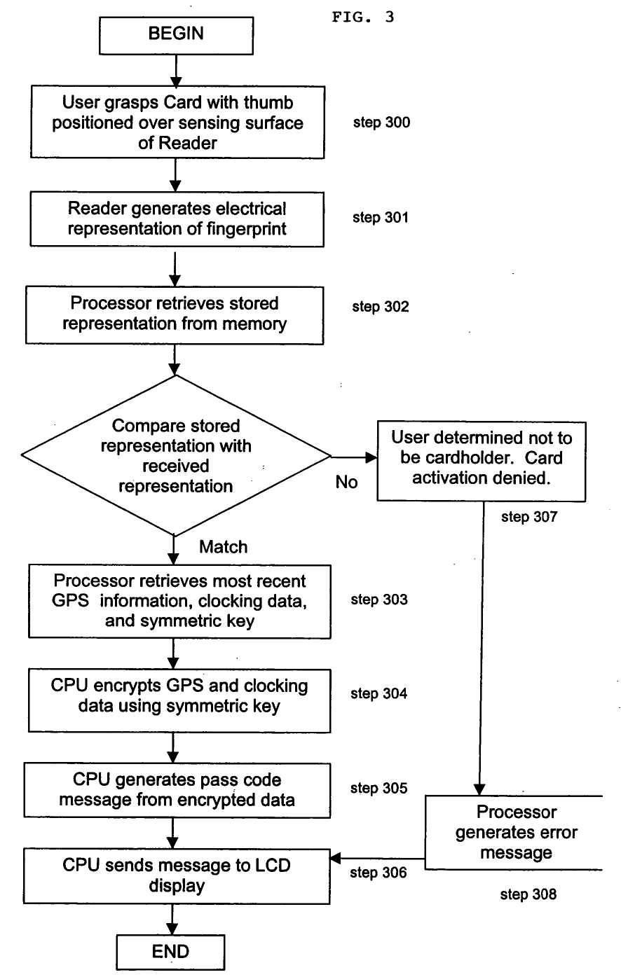

In a preferred embodiment, as illustrated in FIG. 3, wherein the operation of the disclosed invention is exemplified, without intended limitation, processor 27 receives a signal from sensing area 11 indicative of the presence of a contact on its surface, for example the thumb of the user (Step 300). In response to receipt of a signal from sensing area 11, a reader included in processor 27 translates the biometric signal, e.g., the imprint from a digit, such as the finger or thumb, into a fingerprint signal (Step 301). The method by which the reader of processor 27 translates the fingerprint of the user into a usable signal may be any method known in the art for reading fingerprints electronically.

Processor 27 then forwards a request signal to memory 25 in response to the reading of the fingerprint. Memory 25, coupled to processor 27, stores, for example, a verication signal, preferably a fingerprint signal, of the authorized cardholder. Once memory 25 receives a request signal from processor 27, memory 25 forwards the stored verification fingerprint signal to processor 27 (Step 302). Processor 27 then compares the fingerprint signal from the reader and the verification fingerprint signal from memory 25 and determines whether the stored fingerprint representation is equivalent to the generated fingerprint representation. Although the authentication device has been described as including a biometric sensor and a memory for storing a verification signal of an authentic user to activate a authentication device, a number pad may also be included for verifying that the user is the authorized user by entering in a personal identification number (PIN) and comparing the entered PIN with a PIN stored in a memory.

As stated above, if processor 27 determines that, based upon the user's fingerprint or other biometric signal, the user is the authorized cardholder, processor 27 references the location signal from locator 21, the clock signal from clock 23, and generates the pseudo-random code (Step 303). Processor 27 encrypts the location signal, the code generated by the code generator, and clock signal (Step 304), which then generates the OTP therefrom (Step 305). Once the OTP has been generated, the OTP is displayed to the user on display 12 (Step 306). If processor 27 determines that the user is not the authorized user, the activation of card 10 is denied (Step 307) and an error message is generated by processor 27 (Step 308). The error message is then displayed (Step 306).

Once the card has been activated, and card 10 has generated an OTP for the transaction, the user enters the OTP into a card terminal or form field on a computer, for example. The OTP entered by the cardholder is then forwarded to the device issuer through a network coupled to the device used by the cardholder to enter the OTP. Although the OTP has been disclosed as requiring manual entry into a card terminal or form field, it should be noted that for other embodiments of the card, the OTP may be automatically forwarded to the issuer network by the card reader, such as a smart card reader or facility access device.

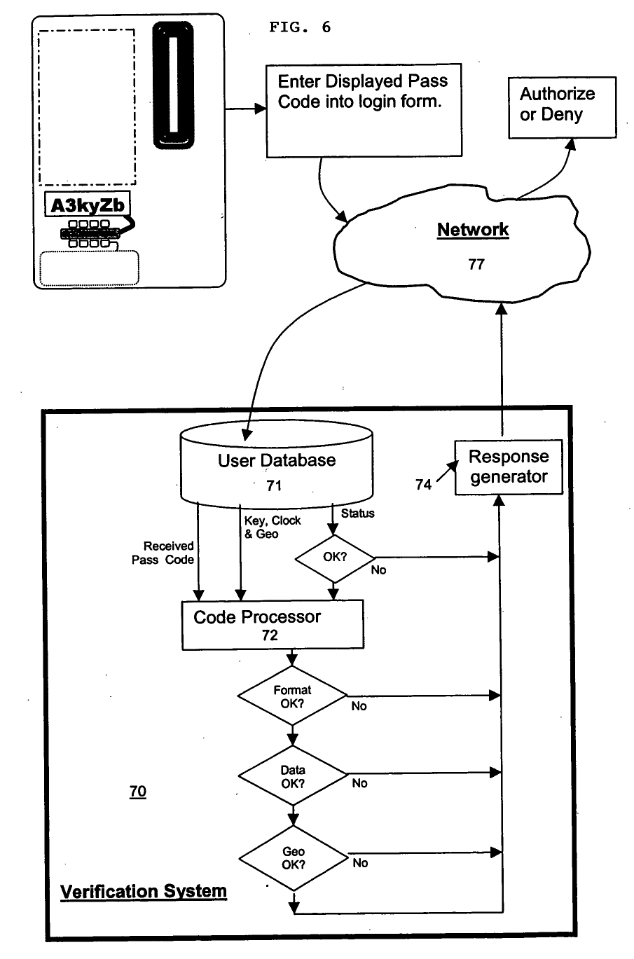

FIG. 6 is an exemplary block diagram of an issuer network in accordance with a preferred embodiment of the present invention. For exempary purposes, the issuer network is that of a credit card issuer. It should be noted that the issuer network illustrated in FIG. 6 may be associated with any device issuer. Network 77 may be any means of connecting a user to a device issuer, i.e., the internet, a LAN, a credit card and ATM network, or a facility security network. Network 77 forwards transaction, account information and the OTP to the issuer's network 70 for verification and authorization.

In the verification system, issuer's network 70 comprises a database 71, a code processor 72 and a response generator 74. The information forwarded by network 77 is received by database 71, which looks up the user's account, confirming that the account number is valid. If card 10 is a credit or debit card being used to purchase an item from a merchant, customer database 71 also confirms that the available credit is greater than the amount of the transaction. A verification signal is then generated by database 71, and forwarded to response generator 74, indicating whether the card is valid, and, if applicable, whether the transaction meets the issuer's purchase criteria. Customer database 71 also forwards the OTP, a key for decrypting the OTP, a clock signal, and location restrictions to code processor 72.

Code processor 72, coupled to database 71 and response generator 74, receives the forwarded information from database 71 and decrypts the received OTP. Code processor 72 then generates an issuer code using the same code algorithm used by processor 27 of card 10. Code processor 72 then determines whether the information received in the OTP meets the criteria set up by the issuer. For example, it determines whether the format of the information is valid, whether the user code and issuer code are the same, and whether the user location information is within the location restrictions. Each of the determinations made by code processor 72 is forwarded to response operator 74.

Response generator 74, coupled to database 71 and code processor 72, receives the signals from database 71 and code processer 72 and generates an authorization signal therefrom. If the user is the authorized user, device 10 is valid, the transaction allowable, and in an area authorized by the issuer, response generator 74 generates an authorization signal indicative of authorization of the user's request. Otherwise response generator 74 generates an authorization signal indicative of a denial of the users request.

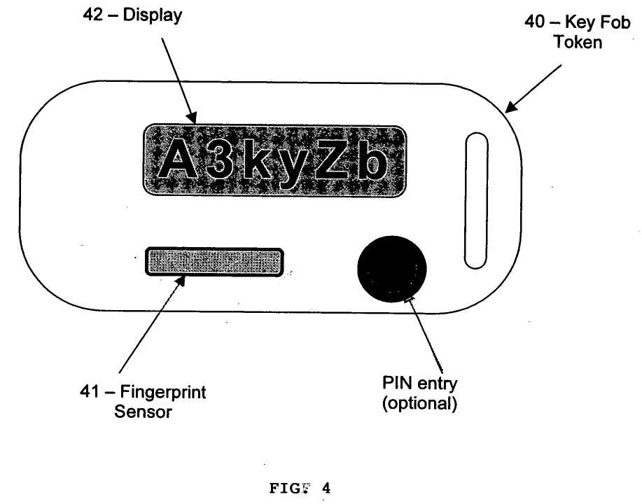

Although a preferred embodiment is described as a card, any authentication device may be utilized having an authentication system as disclosed herein. For example, shown in FIG. 4 is a keyfob device 40 made in accordance with a preferred embodiment of the present invention. Similar to card 10, keyfob device 40 comprises a sensor 41, a display 42, and an authentication system 44. The components of keyfob device 40 operate as set forth above in the preferred embodiment. In a preferred method of use, a user touches sensor 41 of keyfob device 40. If the user is the authorized user, an OTP is displayed on display 42, the OTP preferably including the proximate location of the user as described hereinabove.

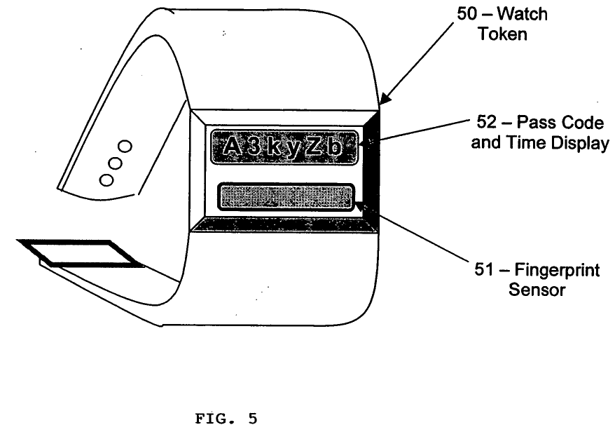

FIG. 5 is an illustration of an alternative authentication device, a watch 50. Again, in accordance with a preferred emdodiment, watch 50 comprises a sensor 51, a display 52 and an authernication system 57. As described hereinabove, watch 50 displays the OTP upon receipt of a valid fingerprint.

The above description and the views and material depicted by the figures are for purposes of illustration only and are not intended to be, and should not be construed as, limitations on the invention. Moreover, certain modifications or alternatives may suggest themselves to those skilled in the art upon reading of this specification, all of which are intended to be within the spirit and scope of the present invention as defined in the attached claims.

We claim:

1. A device for accessing information comprising an authenticator for verifying that a user of the device is the authorized user, the authenticator comprising:
a memory in which a verification user signal is stored;
a locator for generating a location signal indicative of the proximate location of the user at the time of authentication; and
a processor, coupled to the memory and locator, for generating a passcode including the location signal.

2. The device of claim 1, wherein the processor comprises:
a reader for reading a signal entered by the user; and
a code generator for generating a unique code when the signal is equivalent to the stored verification user signal, wherein the code and the location signal are encrypted to generate the passcode.

3. The device of claim 2, further comprising a display area for displaying the passcode.

4. The device of claim 3, wherein the unique code is generated in accordance with a user specific algorithm.

5. The device of claim 2, wherein the locator comprises a geo-locator for receiving location information over a Global Positioning System.

6. The device of claim 2, wherein the locator comprises a geo-locator for receiving location information over a cellular network.

7. The device of claim 3, further comprising a sensor for sensing the fingerprint of said user, wherein said user signal is a fingerprint signal.

8. The device of claim 7, wherein said device is a card.

9. The device of claim 7, wherein said device is a keyfob.

10. The device of claim 7, wherein said device is a watch.

11. A method for authorizing use of the device of claim 1, comprising the steps of:
reading a signal entered by the user;
comparing the read signal to a stored verification user signal;
if the read signal is equivalent to the verification user signal,
retrieving location information relating to the proximate location of the user at the time of authentication; and
generating a passcode including the location information;
forwarding to an issuer, at an issuer network, the passcode; and
authorizing the use of the device in response to the received passcode.

12. The method of claim 11, further comprising:
generating a pseudo-random code for combining with said location information; and
encrypting the combined location information and the pseudo-random code, thereby generating said passcode.

13. The method of claim 12, wherein said authorizing step comprises:
retrieving user specific customer information;
decrypting the received passcode;
verifying that the pseudo-random code generated by said device is equivalent to a pseudo-random code generated by said issuer; and
verifying that the location information from the user is within a location range set by the issuer.

14. The method of claim 13, wherein the issuer network comprises:
a customer database having customer information for a plurality of users;
an issuer code processor, responsive to said customer database, for decrypting said passcode from said user and determining whether said user is allowed access to said information; and
a response generator for generating an authorization signal in response to said code processor and said database.

15. A method for authorizing use of a device, said method comprising the steps of:
reading a signal entered by the user;
comparing the read signal to a stored verification user signal;
if the read signal is equivalent to the verification user signal,
retrieving location information relating to the proximate location of the user at the time of authentication; and
generating a passcode including the location information;
forwarding to an issuer, at and issuer network, the passcode; and
authorizing the use of the device in response to the received passcode.

16. The method of claim 15, further comprising:
generating a pseudo-random code for combining with said location information; and
encrypting the combined location information and the pseudo-random code, thereby generating said passcode.

17. The method of claim 16, wherein said authorizing step comprises:
retrieving user specific customer information;
decrypting said received passcode;
verifying that the pseudo-random code generated by said device is equivalent to a pseudo-random code generated by said issuer; and
verifying that the location information from the user is within a location range set by the issuer.

18. The method of claim 17, wherein the issuer network comprises:
a customer database having customer information for a plurality of users;
an issuer code processor, responsive to said customer database, for decrypting said passcode from said user and determining whether said user is allowed access to said information; and
a response generator for generating an authorization signal in response to said code processor and said database.

18. A system for authorizing use of a device to access information, said system comprising:
the device comprising an authenticator for verifying that the user of the device is an authorized user, the authenticator comprising:
a memory for storing a verification user signal;
a locator for generating a location signal indicative of the proximate location of a user at the time of authentication; and
a processor, coupled to the memory and locator, for generating a passcode including the location signal, said passcode forwarded to an issuer network for authorizing access; and
the issuer network comprising:
a customer database having customer information for a plurality of users;
an issuer code processor, responsive to said customer database, for decrypting said passcode from said user and determining whether said user is allowed access; and
a response generator for generating an authorization signal in response to said code processor and said database.
